(19) United States
(12) Patent Application Publication
(10) Pub. No.: US 2017/0237124 A1
(43) Pub. Date: Aug. 17, 2017

(54) THREE-DIMENSIONAL THIN FILM BATTERY

(71) Applicant: APPLIED MATERIALS, INC., Santa Clara, CA (US)

(72) Inventors: Daoying SONG, San Jose, CA (US); Byung Sung Leo KWAK, Portland, OR (US)

(73) Assignee: APPLIED MATERIALS, INC., Santa Clara, CA (US)

(21) Appl. No.: 15/504,590

(22) PCT Filed: Aug. 27, 2015
(86) PCT No.: PCT/US15/47286

§ 371 Date: Feb. 16, 2017

Related U.S. Application Data
(60) Provisional application No. 62/042,577, filed on Aug. 27, 2014.

(51) Int. Cl. H01M 10/0585; H01M 4/04; H01M 4/131; H01M 4/1391; H01M 10/0562; H01M 4/1395; H01M 4/525; H01M 4/38; H01M 10/0525; H01M 4/70; H01M 4/134

(52) U.S. Cl. CPC H01M 10/0585; H01M 4/70; H01M 4/0404; H01M 4/0407; H01M 4/0426; H01M 4/131; H01M 4/1391; H01M 4/0471; H01M 4/134; H01M 4/1395; H01M 4/525; H01M 4/382; H01M 10/0525; H01M 10/0562; H01M 2300/0068

(57) ABSTRACT

A thin film battery may comprise: a substrate comprising a substrate surface; a first current collector (FCC) layer formed on the substrate surface, the FCC layer having a first FCC surface and a second FCC surface and wherein the first FCC surface is in contact with the substrate and the second FCC surface is a first three-dimensional surface; a first electrode layer deposited on the first current collector, and an electrolyte layer deposited on the first electrode layer; wherein the interface between the first electrode layer and the electrolyte layer is a second three-dimensional surface roughly in conformity with the first three-dimensional surface. In embodiments, the substrate surface is a third three-dimensional surface and the first three-dimensional surface is roughly in conformity with the third three-dimensional surface. One of the first or the third three-dimensional surfaces may be formed by a laser ablation patterning process.

### CROSS-REFERENCE TO RELATED APPLICATIONS

This application claims the benefit of U.S. Provisional Application No. 62/042,557 filed Aug. 27, 2014.

### FIELD

Embodiments of the present disclosure relate generally to thin film batteries and methods of making the same, and more specifically, although not exclusively, to thin film batteries with the surface of one of the substrate and cathode current collector being three-dimensionally restructured by a laser process.

### BACKGROUND

Thin film batteries (TFBs) may comprise a thin film stack of layers including current collectors, a cathode (positive electrode), a solid state electrolyte and an anode (negative electrode). A TFB is generally fabricated as a two dimensional (2D) device and the battery performance (e.g., rate capability and capacity utilization) is limited by the surface area of the cathode-electrolyte and anode-electrolyte interfaces through which Li must diffuse during the intercalation/deintercalation processes. Furthermore, TFBs are known to exhibit peeling/delamination at various interfaces and at various stages of fabrication and operation, such as after cathode annealing, after electrolyte deposition, after anode deposition, after encapsulation deposition, or during battery cycle testing.

Clearly, there is a need for TFB structures and methods of manufacture that induce greater adhesion strength between layers in the TFB stack, and provide a larger interfacial surface area between the cathode and the electrolyte and/or the anode and the electrolyte in order to improve battery performance.

### SUMMARY

Some embodiments of the present disclosure relate to thin film batteries (TFBs) with the surface of one of the substrate and current collector being three-dimensionally restructured by a laser process during battery thin film stack fabrication, followed by depositions of subsequent layers such that the interfacial contact area between the cathode/anode and the electrolyte is a three-dimensional surface roughly in conformity with the three-dimensionally restructured surface of the substrate/current collector. The resulting three-dimensionally structured interfaces between the cathode/anode layer(s) and the electrolyte layer are expected to improve TFB performance (e.g., rate capability and capacity utilization) and increase adhesion strength between layers within the TFB stack sufficiently to reduce peeling/delamination, when compared with a TFB stack having planar interfacial layers.

According to some embodiments, a thin film battery may comprise: a substrate comprising a substrate surface; a first current collector (FCC) layer formed on the substrate surface, the FCC layer having a first FCC surface and a second FCC surface and wherein the first FCC surface is in contact with the substrate and the second FCC surface is a first three-dimensional surface; a first electrode layer deposited on the first current collector, and an electrolyte layer deposited on the first electrode layer; wherein the interface between the first electrode layer and the electrolyte layer is a second three-dimensional surface roughly in conformity with the first three-dimensional surface. Furthermore, in embodiments, the substrate surface is a third three-dimensional surface and said first three-dimensional surface is roughly in conformity with said third three-dimensional surface.

According to some embodiments, a method of making the thin film battery may comprise: providing a substrate; three-dimensionally restructuring the surface of the substrate to form a restructured substrate surface; depositing a first current collector (FCC) layer on the restructured substrate surface; depositing an electrode layer on the FCC layer; and depositing an electrolyte layer on the electrode layer; wherein the interface between the electrode layer and the electrolyte layer is a first three-dimensional surface roughly in conformity with the restructured substrate surface.

According to some further embodiments, a method of making the thin film battery may comprise: providing a substrate; depositing a first current collector (FCC) layer on the surface of the substrate; three-dimensionally restructuring the surface of the FCC layer to form a restructured FCC surface; depositing a first electrode layer on the restructured FCC surface; and depositing an electrolyte layer on the first electrode layer; wherein the interface between the first electrode layer and the electrolyte layer is a first three-dimensional surface roughly in conformity with the restructured FCC surface.

According to some embodiments, an apparatus for manufacturing TFBs according to some embodiments may include: a first system for three-dimensionally restructuring the surface of a substrate to form a restructured substrate surface; a second system for depositing a first current collector (FCC) layer on the restructured substrate surface; a third system for depositing an electrode layer on the FCC layer; and a fourth system for depositing an electrolyte layer on the electrode layer; wherein the interface between the electrode layer and the electrolyte layer is a first three-dimensional surface roughly in conformity with the restructured substrate surface. The first system may comprise, for example, a laser ablation patterning system, in embodiments an ion sputtering system, and in embodiments a mechanical roughening system (such as a bead blaster).

According to some further embodiments, an apparatus for manufacturing TFBs according to some embodiments may include: a first system for depositing a first current collector (FCC) layer on the surface of a substrate; a second system for three-dimensionally restructuring the surface of the FCC layer to form a restructured FCC surface; a third system for depositing a first electrode layer on the restructured FCC surface; and a fourth system for depositing an electrolyte layer on the first electrode layer; wherein the interface between the first electrode layer and the electrolyte layer is a first three-dimensional surface roughly in conformity with the restructured FCC surface. The second system may comprise, for example, a laser ablation patterning system, in embodiments an ion sputtering system, and in embodiments a mechanical roughening system (such as a bead blaster).

### BRIEF DESCRIPTION OF THE DRAWINGS

These and other aspects and features of the present disclosure will become apparent to those ordinarily skilled in the art upon review of the following description of specific embodiments in conjunction with the accompanying figures, wherein:

FIG. 1A is a cross-sectional representation of a thin film battery including a restructured substrate with a three-dimensionally restructured substrate surface, according to some embodiments;

FIG. 1B shows a perspective view of the restructured substrate of FIG. 1A.

FIG. 2 is a flow chart for fabrication of a thin film battery with a restructured substrate with a three-dimensionally restructured surface, according to some embodiments;

FIG. 3 is a cross-sectional representation of a thin film battery including a restructured cathode current collector with a three-dimensionally restructured collector surface, according to some embodiments;

FIG. 4 is a flow chart for fabrication of a thin film battery including a restructured cathode current collector with a three-dimensionally restructured collector surface, according to some embodiments;

FIG. 5 is a schematic illustration of a cluster tool for TFB fabrication, according to some embodiments;

FIG. 6 is a representation of a TFB fabrication system with multiple in-line tools, according to some embodiments; and

FIG. 7 is a representation of an in-line tool of FIG. 6, according to some embodiments.

### DETAILED DESCRIPTION

Embodiments of the present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present specification, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

Some embodiments of the present disclosure relate to thin film batteries (TFBs) with the surface of one of the substrate and cathode current collector (CCC) being three-dimensionally restructured by a laser process during battery thin film stack fabrication, followed by depositions of subsequent layers such that the interfacial contact area between the cathode and the electrolyte is a three-dimensional surface roughly in conformity with the three-dimensionally restructured surface of the substrate/CCC. Furthermore, in some embodiments the electrolyte-anode and anode-ACC interfaces may also be three dimensional surfaces roughly in conformity with the three-dimensionally restructured surface of the restructured substrate/CCC. The resulting three-dimensionally structured interfaces between the cathode layer and the electrolyte layer and the electrolyte layer and the anode layer are expected to improve TFB performance (e.g., rate capability and capacity utilization, especially at higher rates of charging/discharging) and improve interfacial adhesion of layers within the TFB stack sufficiently to reduce peeling/delamination, when compared with a TFB stack having planar interfacial layers. (Roughening of interfaces between layers induces “mechanical wrapping” at the interface for greater adhesion strength.) Moreover, the three-dimensionally structured interface between the cathode layer and the electrolyte layer is expected to increase access to the (003) planes in the polycrystalline grain structures in a LiCoO₂ cathode layer at the interface, which reduces resistance to lithium intercalation/deintercalation during battery usage.

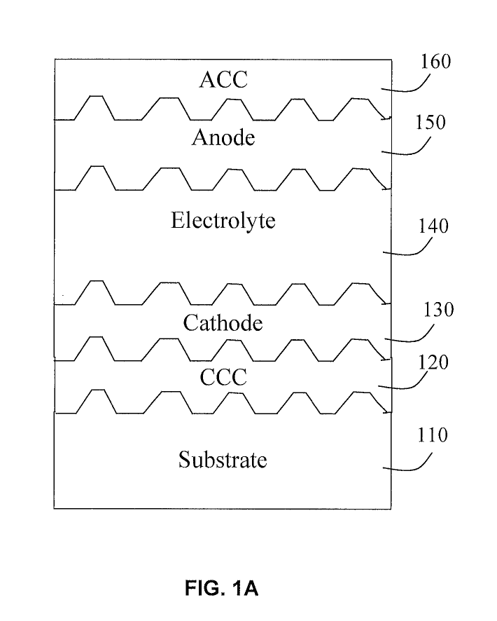

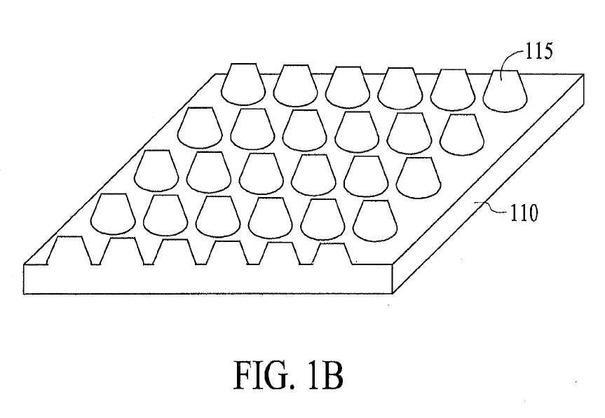

FIGS. 1A & B show an example of a TFB with a vertical stack fabricated according to embodiments of the present disclosure with a three-dimensionally restructured substrate surface. In FIG. 1A, the vertical stack comprises: a restructured substrate 110, the substrate surface having been three-dimensionally restructured by a laser process; a cathode current collector 120 deposited on the surface of the restructured substrate; a cathode layer 130 deposited on the cathode current collector; an electrolyte layer 140 deposited on the cathode layer; an anode layer 150 deposited on the electrolyte layer; and an anode current collector (ACC) 160 deposited on the anode layer. It should be noted that the interfaces between the CCC and the cathode layer and between the cathode layer and the electrolyte layer are three-dimensional surfaces roughly in conformity with the three-dimensionally restructured surface of the restructured substrate. Herein the term “roughly in conformity with” is used to specify that a surface of a deposited layer reproduces the general shape of the three-dimensionally restructured surface due to the layer or layers between the three-dimensionally restructured surface and the surface in question each providing complete coverage but having a layer thickness covering the sidewalls and bottom surfaces of features in the three-dimensionally restructured surface which is less than the layer thickness covering surviving portions of the original surface and field areas. Furthermore, in some embodiments the electrolyte-anode and anode-ACC interfaces may also be three dimensional surfaces roughly in conformity with the three-dimensionally restructured surface of the restructured substrate—as shown in FIG. 1A. The TFB may also include protective coating(s) and electrical contacts, for example. The perspective view of FIG. 1A shows an array of conically shaped features 115 (such as truncated cones) on the restructured surface of the substrate 110, although the features of the restructured substrate surface may be varied in size, shape, spacing and arrangement from what is shown. The features may include cylindrically-shaped features, trapezoidally-shaped features, spherically-shaped features, vias, trenches, and round depressions, for example; to achieve satisfactory step coverage in vias and trenches, positively reentrant shapes (width or diameter at the top is larger than that at the bottom of the features) may be utilized. Feature sizes (as determined in a plane parallel to the original surface of the substrate) may be a few microns to tens of microns. Furthermore, these features may be positioned in regular arrays—a square lattice, for example—and in embodiments these features may be positioned randomly. The density of features may be varied widely—the highest densities corresponding to close-packed arrays. In embodiments, greater than 50 percent of the substrate or CC surface is restructured by forming features as described herein. The depth (measured in the direction perpendicular to the original surface of the substrate) of features will be limited by the substrate thickness—a limit of 75% of the substrate thickness being a reasonable upper limit, although this may be varied as needed to maintain the mechanical integrity of the substrate. Furthermore, in embodiments the depth of features is greater than or equal to 25 percent of the substrate thickness. Furthermore, in embodiments the depth of features is greater than or equal to 5 microns. For example, a 20 micron thick substrate may in embodiments have features with depths within the range of greater than or equal to 5 microns and less than 15 microns.

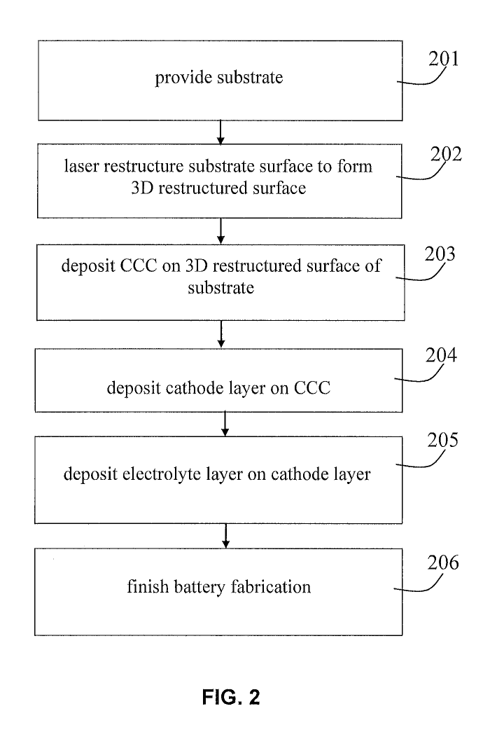

FIG. 2 provides a process flow, according to some embodiments for fabrication of a TFB such as shown in FIGS. 1A & 1B, which includes a three-dimensionally restructured substrate surface. The process flow for fabricating a TFB may include: providing a substrate (201); three-dimensionally restructuring the surface of the substrate by a laser process (202) to form a restructured substrate; depositing a cathode current collector on the restructured substrate (203); depositing a cathode layer on the cathode current collector (204); and depositing an electrolyte layer on the cathode layer (205); wherein the interface between the cathode layer and the electrolyte layer is a three-dimensional surface roughly in conformity with the three-dimensionally restructured surface of the restructured substrate. The battery fabrication may be finished (206) with the deposition of an anode, an anode current collector (ACC), protective coating and electrical contacts, for example. As noted above with reference to FIG. 1A, the electrolyte-anode and anode-ACC interfaces may also be three-dimensional surfaces roughly in conformity with the three-dimensionally restructured surface of the restructured substrate when the electrolyte and anode depositions are to the layers on which they are deposited.

Substrate materials that strongly absorb laser energy are suitable for the process described above with reference to FIG. 2; some example substrate materials are Si, Al, stainless steel, etc. For these substrates a laser energy source is used to restructure the nominally planar substrate surface to form three-dimensional features on the surface. A laser process fluence (typically <2 J/cm² depending on CCC material) is used which is lower than the ablation threshold of the material but higher than the melting threshold of the material—a typical fluence of less than 0.4 J/cm² is used for Au. Laser irradiation of the substrate surface with such fluence levels causes the formation of three-dimensional features such as cone-shaped surface structures, although the shape, height, and density of these three-dimensional features can be controlled by adjusting laser process parameters such as wavelength, fluence, pulse frequency, number of shots, etc. A high power (for example >100 W) nanosecond pulse laser, or even a microsecond pulse laser is typically used for this surface restructuring process. A laser system for this process can be a laser projection system with beam homogenizers, which is typically designed for excimer lasers. In other embodiments the laser system can be a laser scanning system with beam shapers configured to deliver the laser energy uniformly on the sample surface. Lasers of a wide range of types and operating wavelengths (such as IR (infrared), green and UV) may be used according to some embodiments. Suitable laser wavelengths and operating parameters will depend, among other things, on the optical properties (absorptivity vs, wavelength) of the materials undergoing laser surface restructuring. For example, green lasers may be used to cut/shape ceramic substrates, metals, mica, Si, etc., CO₂ lasers may be used to scribe glass substrates, and it is expected that UV lasers may also be able to mark/shape these substrates as well.

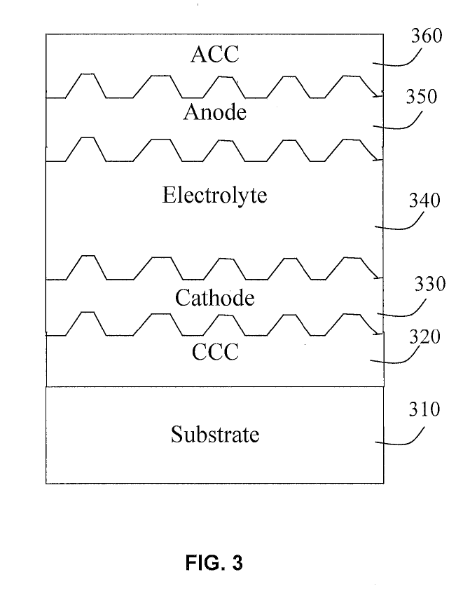

FIG. 3 show an example of a TFB with a vertical stack fabricated according to embodiments of the present disclosure with a three-dimensionally restructured CCC surface. In FIG. 3, the vertical stack comprises: a substrate 310; a restructured CCC 320 formed on the surface of the substrate, the surface of the CCC having been three-dimensionally restructured; a cathode layer 330 deposited on the restructured CCC; an electrolyte layer 340 deposited on the cathode layer; an anode layer 350 deposited on the electrolyte layer; and an ACC 360 deposited on the anode layer. It should be noted that the interface between the cathode layer and the electrolyte layer is a three-dimensional surface roughly in conformity with the three-dimensionally restructured surface of the restructured substrate. Furthermore, in some embodiments the electrolyte-anode and anode-ACC interfaces may also be three dimensional surfaces roughly in conformity with the three-dimensionally restructured CCC surface. The TFB may also include protective coating(s) and electrical contacts, for example. The perspective view of FIG. 1A, described above, is representative of the three-dimensionally restructured surface of the CCC; the features of the restructured surface of the CCC are shown as conically shaped features in FIG. 3, although the features of the restructured substrate surface may be varied in size, shape, spacing and arrangement from what is shown and may include cylindrical features, trapezoidal features, spherical features and randomly placed features, for example.

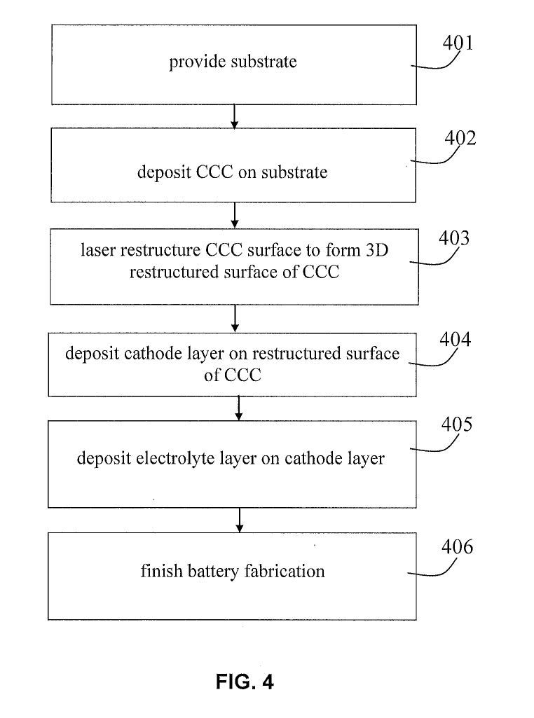

FIG. 4 provides a process flow, according to some embodiments for fabrication of a TFB such as shown in FIG. 3, which includes a three-dimensionally restructured CCC surface. The process flow for fabricating a TFB may include: providing a substrate (401); depositing a CCC on the restructured substrate (402); three-dimensionally restructuring the surface of the CCC (403) to form a restructured CCC; depositing a cathode layer on the restructured CCC (404); and depositing an electrolyte layer on the cathode layer (405); wherein the interface between the cathode layer and the electrolyte layer is a three-dimensional surface roughly in conformity with the three-dimensionally restructured surface of the restructured CCC. The battery fabrication may be finished (406) with the deposition of an anode, an anode current collector (ACC), protective coating and electrical contacts, for example. As noted above with reference to FIG. 3, the electrolyte-anode and anode-ACC interfaces may also be three-dimensional surfaces roughly in conformity with the three-dimensionally restructured surface of the restructured CCC.

The surface of the CCC may be restructured by a laser process as described in more detail herein, or another process may be used, such as mechanical roughening (e.g. bead blasting), plasma processing and ion bombardment, for example. Note that some of these other processes which are non-thermal may be suitable for three dimensionally restructuring the cathode and/or electrolyte surfaces, where the phase and crystallinity of the cathode and/or electrolyte needs to be preserved.

Cathode current collectors are typically formed of metal layers deposited to a thickness of about 0.5 microns or greater and strongly absorb laser energy and are suitable for the process described above with reference to FIG. 4; some example CCC materials are Au or Pt with some adhesion layers, etc. For these substrates a laser energy source is used to restructure the nominally planar CCC surface to form three-dimensional features on the surface. A laser process fluence (typically <2 J/cm² depending on CCC material) is used which is lower than the ablation threshold of the material but higher than the melting threshold of the material—a typical fluence of less than 2 J/cm² is used for Ti and Au. Laser irradiation of the substrate surface with such fluence levels causes the formation of three-dimensional features such as cone-shaped surface structures, although the shape, height, and density of these three-dimensional features can be controlled by adjusting laser process parameters such as wavelength, fluence, pulse frequency, number of shots, etc. A high power (for example >100 W) nanosecond pulse laser, or even a microsecond pulse laser is typically used for this surface restructuring process. Note that this embodiment is well suited to TFBs formed on transparent substrates such as glass, quartz, mica, etc., although this embodiment is not limited to use with these substrates and will work equally well for non-transparent substrates, for example.

It should be noted that substrate and CCC surfaces can be restructured using traditional mask imaging followed by wet and/or plasma etch. However, this approach is only readily available for use with a limited number of materials, such as silicon, for example, and involves multiple steps and adds significant cost to the fabrication of TFB products, when compared to the process of the embodiments disclosed herein. Furthermore, laser restructuring of LiCoO₂ cathode layers prior to electrolyte deposition has been evaluated by the inventors and it has been determined that laser restructuring of LiCoO₂ cathode layers results in phase separation of the LiCoO₂ layer into high temperature (HT) LCO and Co₃O₄, which overall negatively affects battery performance and as such is highly undesirable for thin cathode TFBs. (The impurity phase Co₃O₄ is detrimental to battery charge capacity and also to cycle life.)

An example of a cathode layer is a LiCoO₂ layer, of an anode layer is a Li metal layer, and of an electrolyte layer is a LiPON layer. However, it is expected that a wide range of cathode materials such as NMC (NiMnCo oxide), NCA (NiCoAl oxide), LMO (LiₓMnO₂), LFP (LiₓFePO₄), LiMn spinel, etc. may be used, a wide range of anode materials such as Si, Sn, C, etc. may be used, and a wide range of lithium-containing electrolyte materials such as LLZO (LiLaZr oxide, such as Li₇La₃Zr₂O₁₂), LiSiCON, Ta₂O₅, etc. may be used. Deposition techniques for these layers may be any deposition technique that is capable of providing the desired composition, phase and crystallinity, and may include deposition techniques such as PVD (physical vapor deposition), reactive sputtering, non-reactive sputtering, RF (radio frequency) sputtering, multi-frequency sputtering, evaporation, CVD (chemical vapor deposition), ALD (atomic layer deposition), etc. and when non-vacuum techniques are applicable, may also include slot die coating, plasma spray, spray pyrolysis, electroplating, slurry based screening, etc.

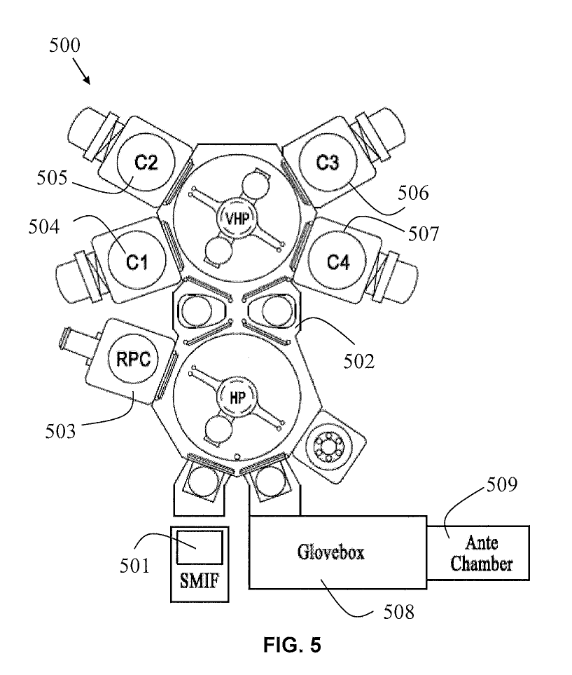

FIG. 5 is a schematic illustration of a processing system 500 for fabricating a TFB, according to some embodiments. The processing system 500 includes a standard mechanical interface (SMIF) 501 to a cluster tool 502 equipped with a reactive plasma clean (RPC) chamber 503 and process chambers C1-C4 (504, 505, 506 and 507), which may be utilized in the process steps described above. A glovebox 508 may also be attached to the cluster tool. The glovebox can store substrates in an inert environment (for example, under a noble gas such as He, Ne or Ar), which is useful after alkali metal/alkaline earth metal deposition. An ante chamber 509 to the glovebox may also be used if needed—the ante chamber is a gas exchange chamber (inert gas to air and vice versa) which allows substrates to be transferred in and out of the glovebox without contaminating the inert environment in the glovebox. (Note that a glovebox can be replaced with a dry room ambient of sufficiently low dew point as such is used by lithium foil manufacturers.) The chambers C1-C4 can be configured for process steps for manufacturing TFBs which may include, for example: deposition of a CCC on a substrate, followed by three dimensionally restructuring the surface of the CCC by a laser process, followed by deposition of a cathode layer on the restructured CCC surface, followed by deposition of an electrolyte layer (for example UPON by RF sputtering a Li₃PO₄ target in N₂) on the cathode layer, as described above. (Note that the three dimensional restructuring may be done in a cluster tool as described herein, or may be done in a stand alone tool.) Examples of suitable cluster tool platforms include display cluster tools. It is to be understood that while a cluster arrangement has been shown for the processing system 500, a linear system may be utilized in which the processing chambers are arranged in a line without a transfer chamber so that the substrate continuously moves from one chamber to the next chamber.

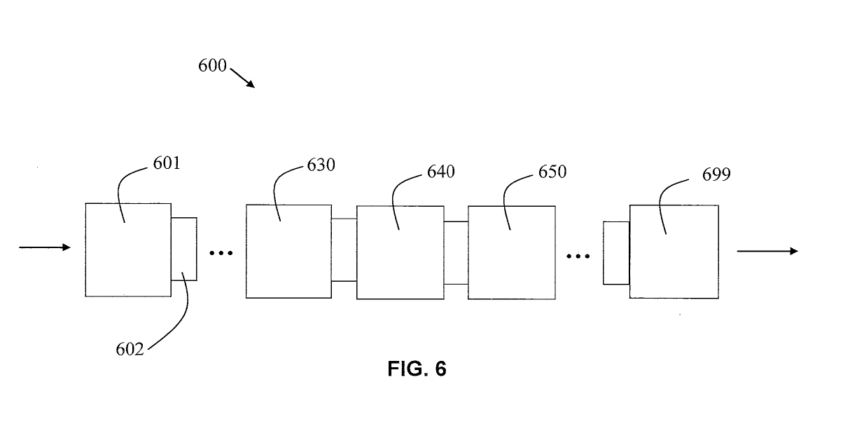

FIG. 6 shows a representation of an in-line fabrication system 600 with multiple in-line tools 601 through 699, including tools 630, 640, 650, according to some embodiments. In-line tools may include tools for depositing all the layers of a TFB, and a tool for three dimensionally restructuring the surface of one of the substrate and CCC. Furthermore, the in-line tools may include pre- and post-conditioning chambers. For example, tool 601 may be a pump down chamber for establishing a vacuum prior to the substrate moving through a vacuum airlock 602 into a deposition tool. Some or all of the in-line tools may be vacuum tools separated by vacuum airlocks. Note that the order of process tools and specific process tools in the process line will be determined by the particular TFB fabrication method being used, for example, as specified in the process flows described above. Furthermore, substrates may be moved through the in-line fabrication system oriented either horizontally or vertically.

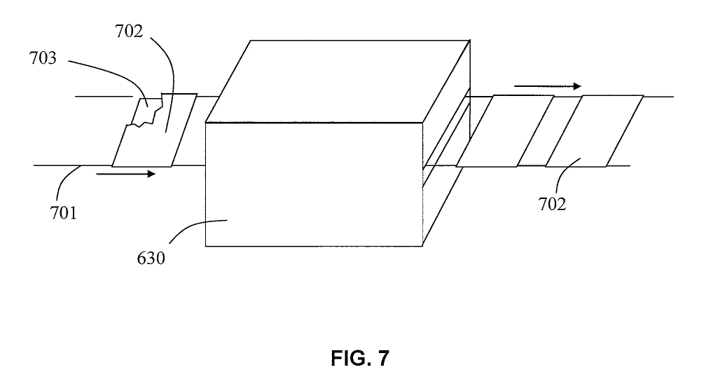

In order to illustrate the movement of a substrate through an in-line fabrication system such as shown in FIG. 6, in FIG. 7 a substrate conveyer 701 is shown with only one in-line tool 630 in place. A substrate holder 702 containing a substrate 703 (the substrate holder is shown partially cut-away so that the substrate can be seen) is mounted on the conveyer 701, or equivalent device, for moving the holder and substrate through the in-line tool 630, as indicated. An in-line platform for processing tool 630 may in some embodiments be configured for vertical substrates, and in some embodiments configured for horizontal substrates.

Some examples of apparatus for fabricating TFBs according to certain embodiments are as follows. An apparatus for manufacturing TFBs according to some embodiments may include: a first system for three-dimensionally restructuring the surface of a substrate to form a restructured substrate surface; a second system for depositing a first current collector (FCC) layer on the restructured substrate surface; a third system for depositing an electrode layer on the FCC layer; and a fourth system for depositing an electrolyte layer on the electrode layer; wherein the interface between the electrode layer and the electrolyte layer is a first three-dimensional surface roughly in conformity with the restructured substrate surface. The first system may comprise, for example, a laser ablation patterning system, in embodiments an ion sputtering system, and in embodiments a mechanical roughening system (such as a bead blaster). Furthermore, in embodiments the apparatus may further comprise: a fifth system for depositing a second electrode layer on the electrolyte layer; wherein the fourth system deposits the electrolyte layer, and wherein the interface between the electrolyte layer and the second electrode layer is a second three-dimensional surface roughly in conformity with the restructured substrate surface. The systems may be cluster tools, in-line tools, stand-alone tools, or a combination of one or more of the aforesaid tools. Furthermore, the systems may include some tools which are common to one or more of the other systems.

Another apparatus for manufacturing TFBs according to some embodiments may include: a first system for depositing a first current collector (FCC) layer on the surface of a substrate; a second system for three-dimensionally restructuring the surface of the FCC layer to form a restructured FCC surface; a third system for depositing a first electrode layer on the restructured FCC surface; and a fourth system for depositing an electrolyte layer on the first electrode layer; wherein the interface between the first electrode layer and the electrolyte layer is a first three-dimensional surface roughly in conformity with the restructured FCC surface. The second system may comprise, for example, a laser ablation patterning system, in embodiments an ion sputtering system, and in embodiments a mechanical roughening system (such as a bead blaster). Furthermore, in embodiments the apparatus may further comprise: a fifth system for depositing a second electrode layer on the electrolyte layer; wherein the interface between the electrolyte layer and the second electrode layer is a second three-dimensional surface roughly in conformity with the restructured FCC surface. The systems may be cluster tools, in-line tools, stand-alone tools, or a combination of one or more of the aforesaid tools. Furthermore, the systems may include some tools which are common to one or more of the other systems.

Although embodiments of the present disclosure have been particularly described with reference to restructuring of either the substrate or the CCC surface, further embodiments include applying the same approach to directly restructuring one or more of the different interfaces on the anode-side of the TFB after electrolyte deposition. (This process may also be done in combination with restructuring of substrate or CCC surfaces.) For example, the surface of the electrolyte layer may be three dimensionally restructured—this process may be suitable for crystalline electrolyte materials such as LLZO.

Although embodiments of the present disclosure have been particularly described with reference to TFB stacks with CCC deposited on the substrate followed by cathode, electrolyte, anode, and then ACC, further embodiments include using the same approach for a TFB stack in which the ACC is deposited on the substrate followed by anode, electrolyte, cathode and CCC, wherein the substrate and/or ACC is three dimensionally restructured as described above, and the surfaces of one or more subsequently deposited layers will also be three dimensional surfaces roughly in conformity with the three-dimensionally restructured substrate and/or CCC surface.

Although embodiments of the present disclosure have been particularly described with reference to TFBs, the principles and teaching of the present disclosure may be applied to other electrochemical devices, including energy storage devices generally, and also to electrochromic devices. It should be noted that in the case of electrochromic devices interface roughening may lead to undesired diffuse scattering and a device with an undesirable “hazy” appearance, although the roughened interface may improve the device speed; for certain applications the trade-off between optical quality and device speed may be worthwhile, and furthermore the interface roughness may be designed to provide an improvement in speed while not unduly degrading the optical appearance.

Although embodiments of the present disclosure have been particularly described with reference to TFBs with a first current collector layer on the surface of a substrate, the principles and teaching of the present disclosure may be applied to certain TFBs without a current collector layer on the surface of the substrate—for example, TFBs with electrically conductive substrates. In embodiments a thin film battery may comprise: a substrate comprising a substrate surface, wherein the substrate surface is a first three-dimensional surface; a first electrode layer deposited on the substrate, and an electrolyte layer deposited on the first electrode layer; wherein the interface between the first electrode layer and the electrolyte layer is a second three-dimensional surface roughly in conformity with the first three-dimensional surface. According to some embodiments, a method of making the thin film battery may comprise: providing a substrate; three-dimensionally restructuring the surface of the substrate to form a restructured substrate surface; depositing an electrode layer on the restructured substrate surface; and depositing an electrolyte layer on the electrode layer; wherein the interface between the electrode layer and the electrolyte layer is a first three-dimensional surface roughly in conformity with the restructured substrate surface. According to some embodiments, an apparatus for manufacturing TFBs according to some embodiments may include: a first system for three-dimensionally restructuring the surface of a substrate to form a restructured substrate surface; a second system for depositing an electrode layer on the restructured substrate surface; and a third system for depositing an electrolyte layer on the electrode layer; wherein the interface between the electrode layer and the electrolyte layer is a first three-dimensional surface roughly in conformity with the restructured substrate surface.

Although embodiments of the present disclosure have been particularly described with reference to certain embodiments thereof, it should be readily apparent to those of ordinary skill in the art that changes and modifications in the form and details may be made without departing from the spirit and scope of the disclosure.

1. A thin film battery, comprising:
a substrate comprising a substrate surface;
a first current collector (FCC) layer formed on said substrate surface, said FCC layer having a first FCC surface and a second FCC surface and wherein said first FCC surface is in contact with said substrate and said second FCC surface is a first three-dimensional surface;
a first electrode layer deposited on said first current collector, and
an electrolyte layer deposited on said first electrode layer;
wherein the interface between said first electrode layer and said electrolyte layer is a second three-dimensional surface roughly in conformity with said first three-dimensional surface.

2. The thin film battery of claim 1, wherein said first three-dimensional surface comprises an array of patterned shapes.

3. The thin film battery of claim 1, wherein said substrate surface is a third three-dimensional surface and said first three-dimensional surface is roughly in conformity with said third three-dimensional surface.

4. The thin film battery of claim 1, further comprising:
a second electrode layer deposited on said electrolyte layer; and
a second current collector (SCC) layer deposited on said second electrode layer;
wherein said electrolyte layer is deposited on said first electrode layer and wherein the interface between said second electrode layer and said electrolyte layer is a fourth three-dimensional surface roughly in conformity with said first three-dimensional surface.

5. The thin film battery of claim 4, wherein the interface between said second electrode layer and said SCC layer is a fifth three-dimensional surface roughly in conformity with said fourth three-dimensional surface.

6. The thin film battery of claim 1, wherein said FCC layer is a cathode current collector layer and said first electrode layer is a cathode layer.

7. The thin film battery of claim 1, wherein said FCC layer is an anode current collector layer and said first electrode layer is an anode layer.

8. The thin film battery of claim 4, wherein said FCC layer is a cathode current collector layer and said first electrode layer is a cathode layer, and wherein said second electrode layer is an anode and said SCC layer is an anode current collector layer.

9. The thin film battery of claim 4, wherein said FCC layer is an anode current collector layer and said first electrode layer is an anode layer, and wherein said second electrode layer is a cathode and said SCC layer is a cathode current collector layer.

10. A method of manufacturing a thin film battery, comprising:
providing a substrate;
three-dimensionally restructuring the surface of said substrate to form a restructured substrate surface;
depositing a first current collector (FCC) layer on said restructured substrate surface;
depositing an electrode layer on said FCC layer; and
depositing an electrolyte layer on said electrode layer;
wherein the interface between said electrode layer and said electrolyte layer is a first three-dimensional surface roughly in conformity with said restructured substrate surface.

11. The method of claim 10, further comprising:
depositing a second electrode layer on said electrolyte layer;
wherein the interface between said electrolyte layer and said second electrode layer is a second three-dimensional surface roughly in conformity with said restructured substrate surface.

12. A method of manufacturing a thin film battery, comprising:
providing a substrate;
depositing a first current collector (FCC) layer on the surface of said substrate;
three-dimensionally restructuring the surface of said FCC layer to form a restructured FCC surface;
depositing a first electrode layer on said restructured FCC surface; and
depositing an electrolyte layer on said first electrode layer;
wherein the interface between said first electrode layer and said electrolyte layer is a first three-dimensional surface roughly in conformity with said restructured FCC surface.

13. The method of claim 10, wherein said three-dimensionally restructuring comprises a laser ablation patterning process.

14. The method of claim 12, wherein said three-dimensionally restructuring comprises a mechanical roughening process.

15. The method of claim 12, further comprising:
depositing a second electrode layer on said electrolyte layer;
wherein the interface between said electrolyte layer and said second electrode layer is a second three-dimensional surface roughly in conformity with said restructured first current collector surface.

16. The method of claim 12, wherein said three-dimensionally restructuring comprises a laser ablation patterning process.
